(19) United States
(12) Patent Application Publication
(10) Pub. No.: US 2012/0017400 A1
(43) Pub. Date: Jan. 26, 2012

(54) Cord clamping device

(76) Inventor: Tim James Ussher, Leatherhead (GB)

(21) Appl. No.: 12/804,382

(22) Filed: Jul. 21, 2010

(51) Int. Cl. F16G 11/10

(52) U.S. Cl. 24/136 L

(57) ABSTRACT

This invention relates to a cord clamp with push button quick release which is adapted to bind one or more flexible cords or strings at a desired location therealong by freely pulling said cord to the desired point of binding upon which the cord is clamped against retreating until such time as the button is depressed upon which the cord is freely released. Although this invention may be employed for various applications it is especially well suited for fastening/tightening footwear laces and draw strings of clothing and bags. Where the clamping device is fixed in position on the footwear, clothing, bag or other item the user may single-handedly adjust the cord in the clamp simply by pulling the cord to fasten the cord at the required length or tighten it to the required tension and single-handedly release said cord by depressing said button.

### FIELD OF THE INVENTION

The present invention concerns a quick release cord clamping device that is suitable for use to fasten cords. The cords to be clamped may be flexible strips of any suitable type or material, whether woven or not, and may be rope or string, or simply lengths of nylon or leather, for example. The cords may be shoe laces or drawstrings of clothing or for a variety of other purposes.

### BACKGROUND TO THE INVENTION

A range of different clamping devices exist for securely retaining flexible cord in a fixed position with respect to the clamp, whilst allowing the cord to be drawn freely through the clamp in one direction and clamped and prevented from being released in the alternative direction. Such clamping devices are used for fastening footwear laces and adjusting drawstrings/tightening strings of outdoor clothing and sportswear and drawstrings of rucksacks and other bags as well as in household items such as Venetian or roller blind adjustment cords. Other activities employing rope, and other cord, where the cords and ropes are required to be held at desired adjustable points along their length and quickly released and re-clamped include sailing and climbing and these use cord clamping devices of the type in question too.

To secure guy-ropes, hawsers and mooring lines on boats at selected lengths one of the commoner clamping devices comprise a pair of pivoted cleat grippers with serrated opposing faces that pivot together to hold the rope in one direction of pull of the rope between them but pivot apart in the other direction of pull. See for example, U.S. Pat. No. 7,287,304. Such devices do largely, however, require the cord or rope to be pulled in a highly oriented way both further in towards the user and also upwards in order to release the cord entirely from the gripping jaws. Where the cord has to be removed from passing by the clamps, the clamps are not moved open, and once the cord is released it is free to move about anywhere and has to be aligned back into the jaws for reuse. Some pivoted cleat grippers employ spring-biasing to keep one or both grippers with their serrated faces biting into the rope. Some even have cam mechanisms for applying and releasing the grippers from the rope. There is, however, no provision for drawing the rope into the unit without having to disengage the cam and conversely the release of the rope is not completely rapid and easy to achieve.

Cord clamps with a pivoting pair of gripping jaws are also used for roller/Venetian blinds, where the user has to negotiate the cord to pass between two opposing toothed roller clasps in order to satisfactorily grip and hold the cord, and also release the cord by negotiating the cord to push back and disengage one of the sliding roller clasps. A further type of cord clamp, commonly known as a toggle fastening, is used for fastening/tightening shoe laces or drawstrings of clothing and bags. See for example U.S. Pat. No. 4,328,605. This comprises a spring-loaded push-button clamp in a cylindrical body where depressing the spring loaded button into the body aligns a cord passage through the base of the button relative to a passage across the body to allow a cord to be pulled through across the body in either direction. Release of the button causes it to spring back to move the passages out of alignment so that the cord will be gripped. This arrangement, like the others, also requires the user to operate the button when manually moving the clasp up the cords to tighten the draw cords. The adjustment of the cord cannot be done single-handedly.

It is an objective of the present invention to provide a novel cord clamping device incorporating a quick release mechanism that allows for the possibility of single-handed cord adjustment when using the device to fasten a cord at a required length or tighten it to a required tension.

### SUMMARY OF THE INVENTION

According to a first aspect of the present invention there is provided a cord clamping device that comprises: a body having a passage for a cord to pass therethrough, a pair of co-operating grippers each having a respective gripping surface located on opposing sides of the passage to be able to grip the cord therebetween and whereof at least one of the grippers is a moving gripper that is mounted to the body and urged by resilient-biasing means to move its gripper surface towards a gripping position to grip the cord against the opposing gripper's gripping surface or is movable away therefrom to release the cord and wherein a manually operable plunger is provided to drive the moving gripper away from the gripping position against the action of the resilient-biasing means.

The resilient biasing means is preferably a compression coil spring or a leaf spring/band spring.

Preferably the plunger is operated by a push-button. Particularly preferably the moving gripper is pivoted to move towards or away from the gripping position and preferably the opposing gripper is static. The opposing gripper is suitably integrally formed or assembled to an inner wall of the body. Suitably each gripping surface comprises at least one tooth and preferably a plurality of teeth, being a serrated surface.

Advantageously the plunger is configured to engage with a sloped cam surface to drive the moving gripper away from the gripping position. The cam surface is suitably on the moving gripper and is preferably provided in a recess in the moving gripper that the plunger projects into. The plunger preferably is urged by resilient-biasing means to an inactive state where it does not drive the plunger away from the gripping position.

Preferably the body has a cavity in its upper surface that receives and holds captive a said push button that allows the button to reciprocate up and down, raising the plunger up or lowering it down into the body. Preferably the body has an aperture at opposing ends thereof to define the passage and the plunger is substantially orthogonal to the passage.

The pivot pin of said moving gripper may be substantially orthogonal to the longitudinal axis of the plunger but more preferably is substantially parallel thereto allowing for greater compactness of the assembly. In the former case the plunger suitably acts at or near a trailing edge of the moving gripper which is situated above the cord with the other gripper below the cord and in the latter case the plunger suitably acts at or near a leading edge of the moving gripper adjacent the gripping surface of the moving gripper. The limits of substantially orthogonal and substantially parallel would preferably be in the order of say 20 degrees either side of orthogonal or parallel respectively.

The cord clamp avoids the need for tying laces or drawstrings. It allows the cord to pass through the clamp in one ‘draw in’ direction and holds the cord at the desired point where the cord ceases to be pulled through the clamp assembly, preventing the cord from retreating in the ‘let out’ direction opposite to the direction the cord was being pulled. It also allows the cord to be released immediately by depressing a push button on the assembly thus opening the movable binding clasp and freeing the cord.

The present invention is a substantial improvement over existing cord clamps. It provides within a single compact assembly an arrangement that enables a cord to be freely drawn through opposing grippers/jaw clamps in one direction while holding the cord from returning back in the opposite direction, the clamp holding the cord firm at any desired point, without any manually operated locking device needing to be operated to pull the drawstring, cord, rope or lace cord through. The lace/drawstring tightening action can be done single-handedly and simultaneously and as part of that drawing action the cord can be clamped at the desired point or tension utilising the same one hand on the cord. The cord may then be fully or partially released, slackened or let out quickly simply by depressing the push button on the unit. The immediate release and freeing of the cord is enabled without having to manipulate the cord, by depressing the push button thus opening and disengaging the clamp from the cord, whereby the cord may move freely in either direction along the cord passage as the push button remains depressed.

The clamping device may usefully be incorporated into a powered shoe tightening system with lace cord guiding system as set forth in our earlier U.S. Pat. No. 7,752,774 and UK Patent GB2449722, and is complementary to both automatic or manual shoe lace systems.

### BRIEF DESCRIPTION OF THE SEVERAL VIEWS OF THE DRAWINGS

Preferred embodiments of the present invention will now be further described, by way of example only, with reference to the accompanying drawings, in which:

FIG. 1 is an end elevation view of the cord clamping device, showing the push button release mechanism in its inactive retracted position whereby the pivoting clamp is spring-urged onto the cord, engaging the cord and holding the cord from retreating in one direction;

FIG. 2 is an end elevation view of the cord clamp to FIG. 1 but with the push button release mechanism in the active extended position whereby the pivoting spring-biased clamp is driven back from the cord against the spring and thereby releasing the cord;

FIG. 3 is a plan view from above of the clamping mechanism of the cord clamping device (release button removed for clarity), showing the engaged state of the fixed clamp and the pivoting spring-biased clamp on opposing sides of the cord;

FIG. 4 is a plan view from above of the clamping mechanism, corresponding to FIG. 3 but here showing the released state of the clamps;

FIG. 5 is a schematic perspective view from above of the cord clamping device emphasising the push button for release, the spring band resilient biasing means and the static gripper with the plunger poised over the cam recess within the movable gripper;

FIG. 6 is a schematic perspective view from above of the cord clamping device emphasising only the button release unit and associated plunger;

FIG. 7 is a schematic perspective view from above of the cord clamping device emphasising only the opposing grippers and the spring band;

FIG. 8 is an end elevation view of the cord clamping device similar to FIG. 1 but with an alternative body/casing that is adapted for surface mounting the whole unit to an item such as, for example, a shoe or other item of clothing or bag;

FIG. 9 is an end elevation view of the cord clamping device similar to FIG. 1 but with a spring band as an alternative to the coiled spring to bias the movable clamp/gripper;

FIG. 10 is a top plan view of the cord clamping device similar to FIG. 3 but with spring band to bias the movable clamp/gripper;

FIG. 11 is a first side elevation view of a further variant of the cord clamping device wherein the movable clamp/gripper is on a pivot pin orthogonal to the plunger of the push button and acts on a trailing edge of the pivoting movable gripper;

FIG. 12 is a further side elevation view of the FIG. 11 variant in the release position; and

FIG. 13 is an end elevation view of the FIG. 11 variant.

### DESCRIPTION OF THE PREFERRED EMBODIMENT

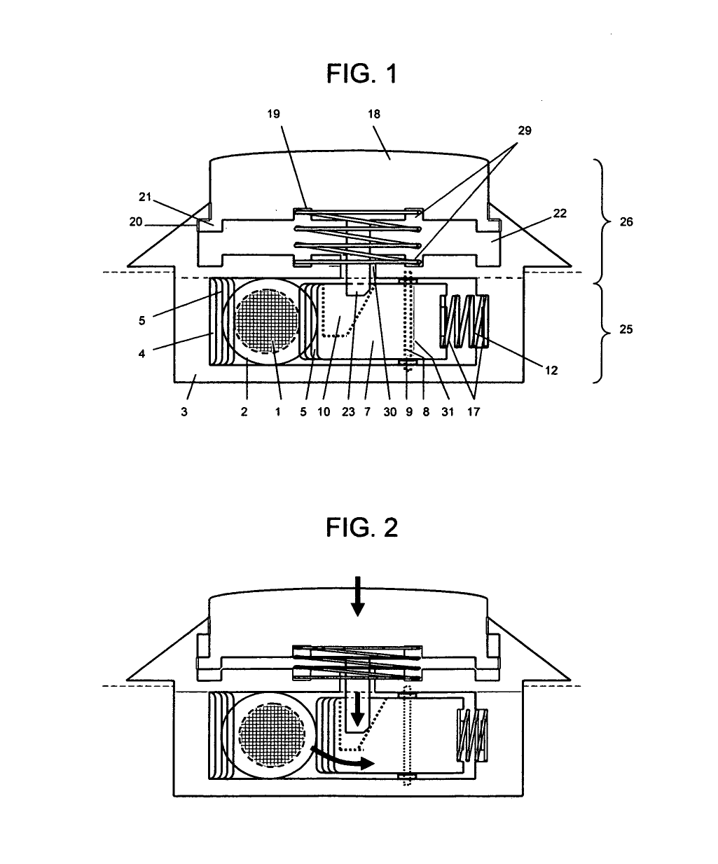

Referring to FIG. 1, the cord clamping device body/casing 3 is shown with a drawstring cord 1 passing through its passage, extending between guiding entry and exit holes 2 at opposing ends of the body in the lower assembly 25 of the device. In the passage within the body the cord 1 runs between a fixed clamp/gripper 4 and a moving clamp/gripper 7. The moving gripper 7 moves by pivoting about a pivot pin 8. Within the body a resilient biasing arrangement 12 is provided to urge the moving gripper 7 towards the cord 1 in order to grip and hold the cord 1 when it is being pulled back against the angle of the teeth of the moving gripper 7. In this first embodiment the resilient biasing arrangement 12 comprises a coiled spring 16.

Both grippers 4, 7 have a serrated gripping face/edge 5 substantially orthogonal to the cord 1 but angled to allow the cord 1 to pass in one direction but be gripped and clamped against retreating in the opposite direction. The serrated gripping edges 5 have a plurality of teeth 6 each with one face larger than the other face next to the cord and angled in such a way as to allow the cord to pass by the clamps in a ‘draw in’ direction 27 aided by the giving movement of the movable clamp/gripper 7 towards its spring mechanism 12. In the other direction the teeth 6 bite into the cord 1 between the two opposing clamps/grippers 4, 7, preventing the cord from travelling in that ‘let out’ direction 28. Increased force attempting to pull the cord in the ‘let out’ direction 28 prompts the offset pivoting movable clamp 7 assisted by its sprung mechanism 12 to grip the cord 1 with increased pressure against the fixed clamp 4.

The upper part of the device's body 3 defines a cavity 22 that houses a push button 18 to manually operate release of the clamping device. This button 18 is biased outwardly by a return coil spring 19, and slides in guiding sleeves 20, being retained in the cavity by a stop shoulder 21 at the lower perimeter of the button 18 abutting a corresponding upper shoulder of the cavity 22. Below the push button 18 is a plunger 23 which projects downwardly and fits inside an indent/recess 10 in the movable clamp/gripper 7 and rides up and down a sloping cam surface therewithin.

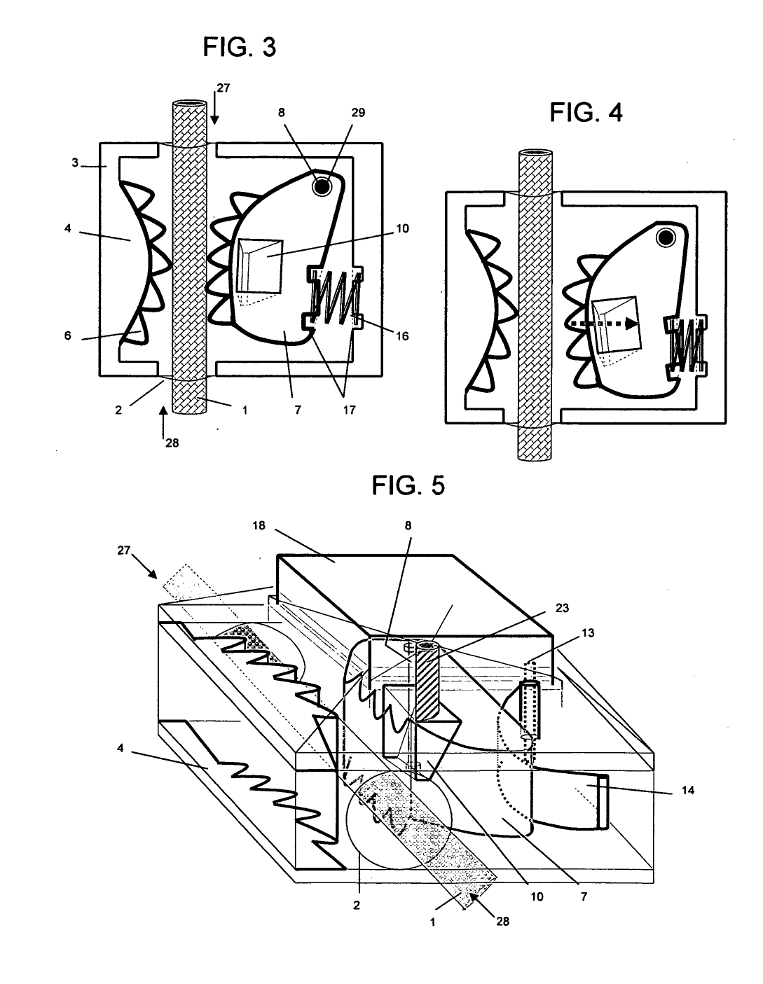

The movable clamp 7 is located between the cord 1, the casing 3 of the unit and the resilient biasing arrangement 12, and has near one end a hole 31 from the top face of the clasp to the bottom face of the clasp through which a pin 8 runs. The pin is fixed to the casing 3 either by screwing it into the bottom of the casing 3 under the movable clamp or by placing both the ends of the pin 8 into small holes within the casing 3 both above and below the movable clamp 7. The movable clamp 7 is free to swivel around the pin 8 within the confines of its position between the cord 1 and the spring mechanism 12. In order to facilitate this free movement preferably a spacer 9 is placed around said pin between the movable clamp 7 and the inner surfaces of the casing 3 both above and below the movable clamp to reduce any friction or sticking. The shape and outer edges of the movable clamp 7 notwithstanding the serrated edge will be of a roundedness so as not to constrict or prevent the free movement of the movable clamp 7 between its positions of being fully clamped onto the cord 1 as per FIG. 3 and fully opened and pushed away from the cord to the recoiled spring 16 as per FIG. 4.

The resting position of the movable clamp 7 as per FIG. 3 is offset from being aligned in parallel with the cord 1, with the pivoting pin end of said clamp further away from the cord 1 than the alternate sprung end of said clamp to facilitate more gripping force on said cord when said cord attempts to be drawn in the ‘let out’ direction 28 further urged by the spring coil mechanism 12 and the angled teeth 6.

The resilient biasing arrangement 12 utilises an elastic assembly or body such as a strip or band of wire of steel or plastic coiled spirally 16 or bent into a curved shape 14, that when pushed towards a flattening direction provides mild resistance whilst yielding, and recovers its shape after being compressed. The resilient biasing arrangement 12 is situated between the trailing face of the movable clamp/gripper 7 (remote to the serrated edge 5) and the inner side of the casing 3, and is in such a position as to urge and push the movable clamp 7 moving the serrated edge 5 onto the cord 1 clamping the cord against the fixed clamp 4. Preferably a coiled spring 16 is utilised with preferably an indented groove 17 in the casing and in the movable clamp to hold the spring coil 16 in place, and should a sprung band be utilised then a pivot pin 13 will pass through and hold one end of said sprung bands looped material in such a way as to provide the necessary push on the movable clamp towards the cord.

The upper part of the device is an upper assembly 26 comprising the push button 18 and plunger 23. The button 18 in part moves internally of the casing 3 and has an exterior portion which protrudes from the casing presenting the push button surface to be depressed, with the button of preferably a solid square shape where the lower part of the underneath of the push button is shaped as a push rod plunger 23 which is either attached to or preferably part of the button moulding 18. The inner sleeve 20 of the casing 3 matingly receives the shoulder 21 of the button allowing the button 18 to travel up and down the guide 22.

Underneath the button is situated a coiled spring 19 located within a holding ring or groove 29 in both the button 18 and the casing 3 whereby the button's push rod 23 is free to move up and down inside the spring coil 19 and through a hole 30 in the casing 3 between the upper assembly 26 and the lower assembly 25. In the resting position the spring 19 extends the button upwards to the point the internal shoulder 21 of the button hits the internal casing.

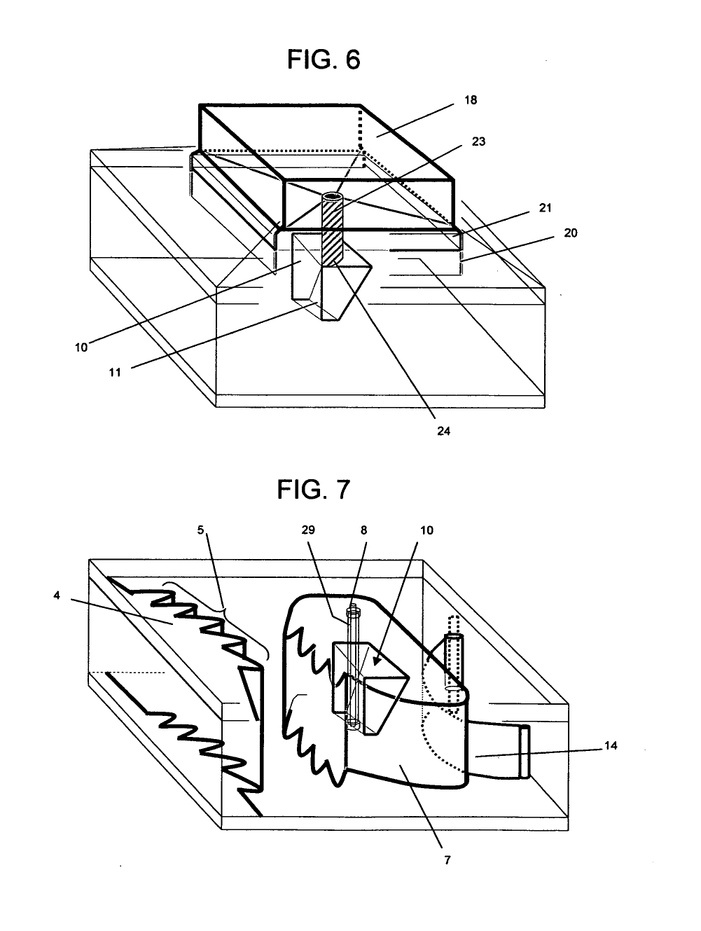

As shown in FIG. 6, the push rod plunger 23 part of the button 18 is preferably of cylindrical shape with a rounded or wedge like angled strike face 24 having its edge facing in the direction of the movable gripper resilient biasing arrangement 12.

As shown in FIG. 6 and FIG. 7, the lower end of the plunger 23 extends into a wedge shaped recess 10 in the upper side of the body of the movable clamp/gripper 7. The strike face of the push rod 23 rests adjacent to the strike face/cam surface 11 of the recess 10 so that as the button 18 is depressed the plunger rod 23 also moves only vertically down through the casing hole 30 so its strike face 24 travelling downwards makes contact with the clamps angled indent face 11 and pushes the movable clamp/gripper 7 recess strike face 11 thereby pushing the movable clamp/gripper 7 away from the cord 1 against and towards and compressing the resilient biasing arrangement 12, as shown in FIG. 4.

The adjacent angles of the strike faces 24 and 11 in relation to the plunger 23 and movable clamp/gripper 7 facilitate an effective and smooth gliding of the plunger's strike face 24, which is of a slightly outwardly rounded surface, down the indent strike face/cam face 11. Upon full travel downwards of the button 18 and plunger 23 as far as permitted by the button's travel guide 22, the plunger 23 will push aside the movable clamp 7 to its furthest position permitted by its compressed resilient biasing arrangement 12 and the casing 3, thereby removing the movable clamp's serrated edge 5 and teeth 6 from clamping against the cord 1 and thus releasing the said cord 1 to move freely whilst the button 18 is depressed.

The size, width and volume of the recess10 and it's strike face 11 and angle should allow the push rod/plunger 23 to effectively and consistently push aside the movable gripper 7 throughout the full travel of the plunger 23, allowing for the slightly changing position of the recess 10 as a result of the full travel of the movable gripper 7 pivoting on its pin 8 in a very slight arc angle and moving its position in relation to said plunger 23. When the button 18 ceases to be depressed the button plunger strike face 24 rises up the movable gripper's recess 10 strike face 11 as urged by the resilient biasing arrangement 12 behind the movable gripper 7. The serrated edge 5 and teeth 6 of the movable gripper 7 are thus returned to their gripping position on the cord 1.

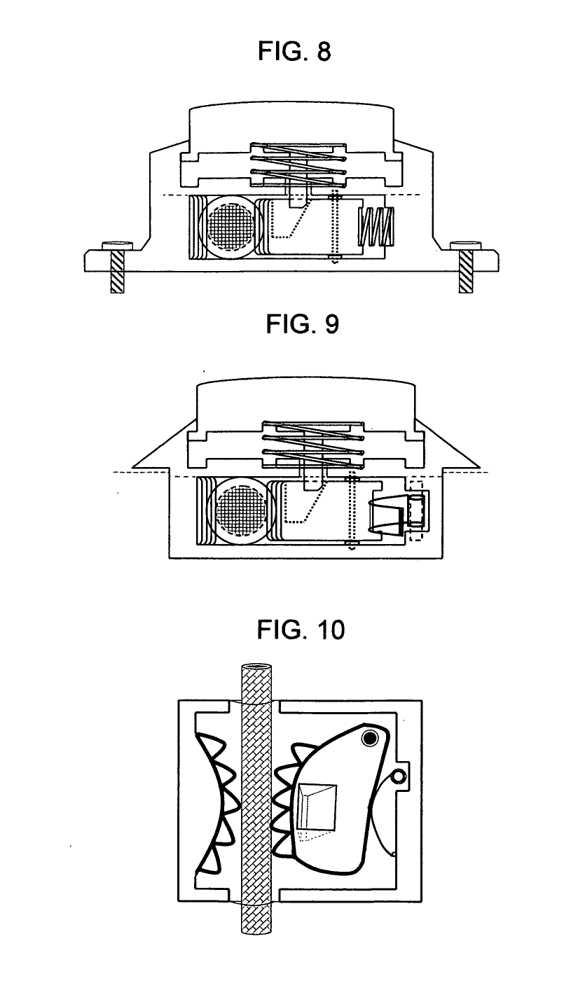

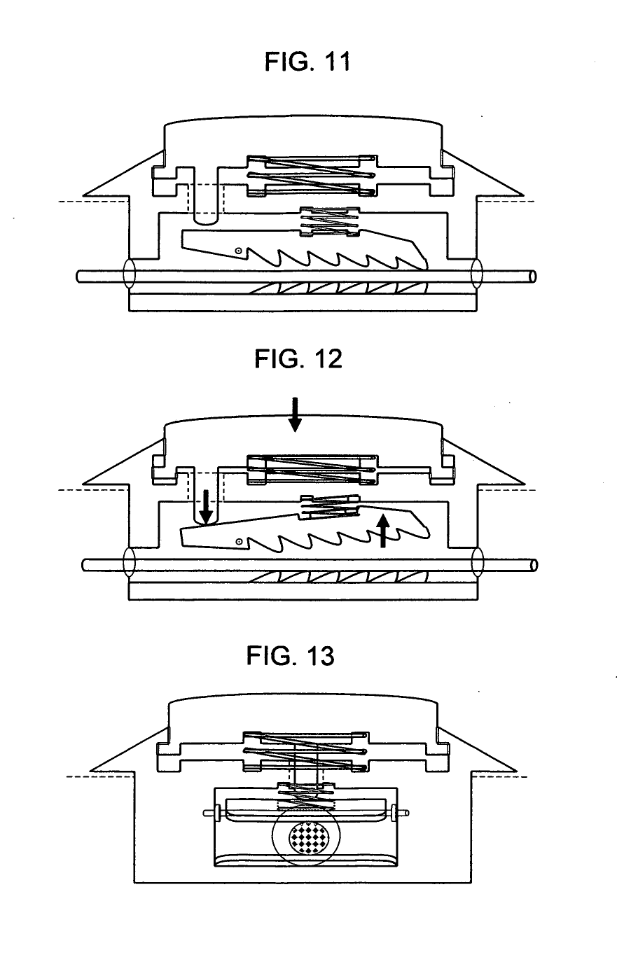

In order to facilitate manufacture of this invention the upper button assembly 26 and the lower clamping assembly 25 should preferably be of separate casing parts which would then be connected in the most suitable method pertaining to the manufacturer preferably by screws, a clip on rim method, epoxy gluing, welding or the like. The unit is preferably attached to or near the item related to the cord pulling and fastening activity, where FIG. 1 exemplifies the lower assembly 25 of the unit being set into an item or surface (see horizontal dashed line) where it is preferable that only the upper external, part of the push button and its surround protrudes with the cord likely to be hidden for example within the upper and lining of a shoe or clothing article. Alternatively FIG. 8 exemplifies the unit being surface mounted where the cord is above surface for example on a boating deck or a wall for the blind.

Although this invention has been described with particularity relative to the foregoing detailed description of the invention, various modifications, changes, additions and applications other than those specifically mentioned herein will be readily apparent to those having normal skill in the art without departing from the spirit and scope of this invention.

1. A cord clamping device that comprises: a body having a passage for a cord to pass therethrough, a pair of co-operating grippers each having a respective gripping surface located on opposing sides of the passage to be able to grip the cord therebetween and whereof at least one of the grippers is a moving gripper that is mounted to the body and urged by resilient-biasing means to move its gripper surface towards a gripping position to grip the cord against the opposing gripper's gripping surface or is movable away therefrom to release the cord and wherein a manually operable plunger is provided to drive the moving gripper away from the gripping position against the action of the resilient-biasing means.

2. A cord clamping device as claimed in claim 1, wherein the resilient biasing means is a compression coil spring or a leaf spring/band spring,

3. A cord clamping device as claimed in claim 1, wherein the plunger is operated by a push-button.

4. A cord clamping device as claimed in claim 1, wherein the moving gripper is pivoted to move towards or away from the gripping position.

5. A cord clamping device as claimed in claim 4, wherein the opposing gripper is static.

6. A cord clamping device as claimed in claim 5, wherein the gripper is integrally formed or assembled to an inner wall of the body.

7. A cord clamping device as claimed in claim 1, wherein each gripping surface comprises at least one tooth or a serrated surface whereof the tooth or teeth is/are angled to allow a cord to be pulled through in one direction but to grip the cord in the other direction.

8. A cord clamping device as claimed in claim 1, wherein the plunger is configured to engage with a sloped cam surface to drive the moving gripper away from the gripping position.

9. A cord clamping device as claimed in claim 8, wherein the cam surface is on the moving gripper and is provided in a recess in the moving gripper that the plunger projects into.

10. A cord clamping device as claimed in claim 1, wherein the plunger is urged by resilient-biasing means to an inactive state where it does not drive the plunger away from the gripping position.

11. A cord clamping device as claimed in claim 1, wherein the body has a cavity in its upper surface that receives and holds captive a said push button that allows the button to reciprocate up and down, raising the plunger up or lowering it down into the body.

12. A cord clamping device as claimed in claim 1, wherein the body has an aperture at opposing ends thereof to define the passage and the plunger is substantially orthogonal to the passage.

13. A cord clamping device as claimed in claim 4, wherein the pivot pin of said moving gripper is substantially parallel to the longitudinal axis of the plunger and the plunger acts at or near a leading edge of the moving gripper adjacent the gripping surface of the moving gripper.

14. A cord clamping device as claimed in claim 1, wherein the body has attachment means to fasten it to an item on which it is to be used.

15. A cord clamping device as claimed in claim 14, wherein the attachment means comprise one or more flanges or body areas that each have an aperture to enable the body to be riveted or sewn or otherwise fastened to a bag or item of clothing.

16. A cord clamping device as claimed in claim 4, wherein the pivot pin of the moving gripper is substantially orthogonal to the longitudinal axis of the plunger and the plunger acts on the moving gripper on the side of the pivot remote from the gripping surface of the moving gripper.
